(19) United States
(12) Patent Application Publication
(10) Pub. No.: US 2025/0253084 A1
(43) Pub. Date: Aug. 7, 2025

(54) COIL COMPONENT

(71) Applicant: Murata Manufacturing Co., Ltd., Kyoto-fu (JP)

(72) Inventors: Shogo NISHIKAWA, Nagaokakyo-shi (JP); Hayato TAKAHASHI, Nagaokakyo-shi (JP); Yuki KANBE, Nagaokakyo-shi (JP); Shingo NAKAMOTO, Nagaokakyo-shi (JP)

(73) Assignee: Murata Manufacturing Co., Ltd., Kyoto-fu (JP)

(21) Appl. No.: 19/034,217

(22) Filed: Jan. 22, 2025

(30) Foreign Application Priority Data
Feb. 7, 2024 (JP) 2024-016962

(51) Int. Cl. H01F 27/00; H01F 5/04; H01F 17/04

(52) U.S. Cl. CPC H01F 27/006; H01F 5/04; H01F 17/045

(57) ABSTRACT

An adverse effect on characteristics of a coil component can be reduced. A coil component includes a drum core and first and second wires. The drum core includes a winding core and first and second flanges. The second wire includes first, second and third wound portions. The second wound portion is located on the second flange side with respect to the first wound portion in a direction along a central axis X, and at least a part of the second wound portion is wound around an outer peripheral surface of the winding core. When the second wire is traced from a first end to a second end in the second wound portion, the second wire has a first intersection and a second intersection intersecting a specific one turn of the first wire within a range where the second wire is wound by two turns.

### CROSS-REFERENCE TO RELATED APPLICATION

This application claims benefit of priority to Japanese Patent Application No. 2024-016962, filed Feb. 7, 2024, the entire content of which is incorporated herein by reference.

### BACKGROUND

### Technical Field

The present disclosure relates to a coil component.

### Background Art

The coil component described in Japanese Patent Application Laid-Open No. 2018-120887 includes a drum-type core, four external electrodes, a first wire, and a second wire. The drum-type core includes a winding core, a first flange, and a second flange. The winding core has a quadrangular prism shape. The first flange is connected to a first end of the winding core. The second flange is connected to a second end of the winding core. Two of the four external electrodes are located on a surface of the first flange. The remaining two external electrodes are located on a surface of the second flange.

The first wire is wound around the winding core. A first end of the first wire is connected to the external electrode on the first flange. A second end of the first wire is connected to the external electrode on the second flange. The second wire is wound around the winding core. A first end of the second wire is connected to the external electrode on the first flange. A second end of the second wire is connected to the external electrode on the second flange. The second wire is wound in the same direction as the first wire. Further, the second wire is wholly wound outside the first wire.

### SUMMARY

In the coil component described in Japanese Patent Application Laid-Open No. 2018-120887, the second wire is wholly wound outside the first wire. Therefore, a length of a portion of the second wire wound around the winding core is longer than that of a portion of the first wire wound around the winding core. The longer the length of the wire wound around the winding core, the larger a DC resistance of the wire. Therefore, when a difference between the length of the first wire wound around the winding core and the length of the second wire wound around the winding core increases, a difference in DC resistance between the wires increases. This difference in DC resistance may adversely affect characteristics required as the coil component.

Accordingly, the present disclosure provides a coil component including a drum core including a columnar winding core, a first flange provided at a first end in a direction along a central axis of the winding core, and a second flange provided at a second end opposite to the first end of the winding core; a first external electrode and a second external electrode provided on the first flange; a third external electrode and a fourth external electrode provided on the second flange; a first wire wound around the winding core and having a first end connected to the first external electrode and a second end connected to the third external electrode; and a second wire wound around the winding core in the same direction as the first wire, and having a first end connected to the second external electrode and a second end connected to the fourth external electrode. The second wire includes a first wound portion wound around an outer peripheral side of the first wire over a plurality of turns; a second wound portion located on the second flange side with respect to the first wound portion in a direction along the central axis, at least a part of the second wound portion being wound around an outer peripheral surface of the winding core; and a third wound portion located on the second flange side with respect to the second wound portion in the direction along the central axis and wound around the outer peripheral side of the first wire over a plurality of turns. Also, when the second wire is traced from the first end to the second end in the second wound portion, the second wire has a first intersection and a second intersection intersecting a specific one turn of the first wire within a range where the second wire is wound by two turns.

According to the above configuration, adverse effects on the characteristics of the coil component can be reduced.

### BRIEF DESCRIPTION OF THE DRAWINGS

FIG. 1 is a perspective view of a coil component according to a first embodiment;

FIG. 2 is a plan view of the coil component according to the first embodiment;

FIG. 3 is a view for describing a winding form of each wire when the coil component of the first embodiment is viewed downward;

FIG. 4 is a view for describing the winding form of each wire when the coil component of the first embodiment is viewed leftward;

FIG. 5 is a view for describing the winding form of each wire when the coil component of a second embodiment is viewed downward;

FIG. 6 is a view for describing the winding form of each wire when the coil component of the second embodiment is viewed leftward;

FIG. 7 is a view for describing the winding form of each wire when the coil component of a third embodiment is viewed downward; and

FIG. 8 is a view for describing the winding form of each wire when the coil component of the third embodiment is viewed leftward.

### DETAILED DESCRIPTION

Hereinafter, a first embodiment, a second embodiment, and a third embodiment of a coil component will be described with reference to the drawings. Note that, in the drawings, a component may be shown in an enlarged manner for easy understanding. A dimension ratio of the component may be different from an actual dimension ratio or a dimension ratio in another drawing.

### First Embodiment

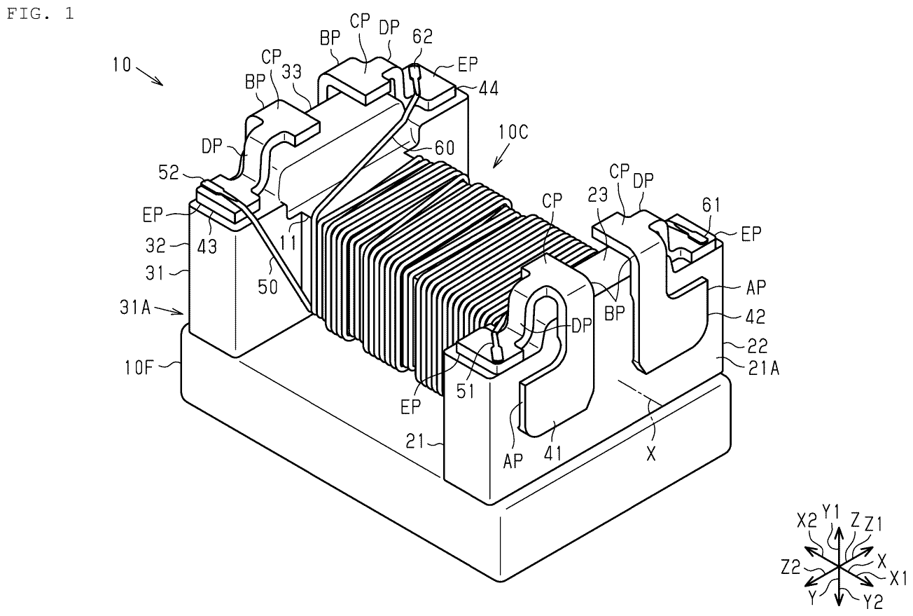

As shown in FIG. 1, a coil component 10 includes a drum core 10C and a plate core 10F.

The drum core 10C includes a winding core 11, a first flange 21, and a second flange 31.

The winding core 11 has a quadrangular prism shape. A material of the winding core 11 is, for example, alumina, Ni—Zn-based ferrite, synthetic resin, or a mixture thereof.

The first flange 21 is provided at a first end of the winding core 11 in a direction along a central axis X. Specifically, the first flange 21 is connected to the first end of the winding core 11 in the direction along the central axis X. The second flange 31 is provided at a second end of the winding core 11 in the direction along the central axis X. Specifically, the second flange 31 is connected to the second end of the winding core 11 in the direction along the central axis X. A material of the first flange 21 and the second flange 31 is the same as that of the winding core 11. Further, the first flange 21 and the second flange 31 are integrally molded with the winding core 11.

Here, a specific axis orthogonal to the central axis X is defined as an up-down axis Y. In the first embodiment, when viewed toward a direction along the central axis X, the up-down axis Y is a direction orthogonal to a mounting surface when the coil component 10 is mounted on a substrate. Further, when viewed toward the direction along the central axis X, the up-down axis Y is parallel to a short side of the winding core 11. Further, an axis orthogonal to both the central axis X and the up-down axis Y is defined as a left-right axis Z. In the first embodiment, the left-right axis Z is parallel to a long side of the winding core 11 when viewed toward the direction along the central axis X. Then, one of directions along the central axis X is defined as a first positive direction X1, and a direction opposite to the first positive direction X1 is defined as a first negative direction X2. In the first embodiment, the first positive direction X1 coincides with a direction from the winding core 11 toward the first flange 21. The first negative direction X2 coincides with a direction from the winding core 11 toward the second flange 31. Further, one of directions along the up-down axis Y is defined as an upward direction Y1, and a direction opposite to the upward direction Y1 is defined as a downward direction Y2. Further, one of directions along the left-right axis Z is defined as a rightward direction Z1, and a direction opposite to the rightward direction Z1 is defined as a leftward direction Z2. Note that the upward direction Y1 and the downward direction Y2 here are referred to for convenience and do not specify a gravity direction. Furthermore, the rightward direction Z1 and the leftward direction Z2 are also referred to for convenience, and do not limit a left-right direction from a specific viewpoint.

In the present disclosure, an “upper surface” refers to a surface facing the upward direction Y1 in a direction along the up-down axis Y, and a “lower surface” refers to a surface facing the downward direction Y2. Note that the “upper surface” is not necessarily strictly orthogonal to the upward direction Y1, and for example, when the coil component 10 is viewed from the upward direction Y1 to the downward direction Y2 with respect to the coil component 10, a visible surface is referred to as an “upper surface of the coil component 10”. The same applies to the lower surface.

The first flange 21 protrudes outward with respect to the winding core 11 in directions along the up-down axis Y and the left-right axis Z when viewed from the direction along the central axis X. The first flange 21 has a shape that is plane-symmetrical with respect to a virtual plane passing through the central axis X and parallel to the central axis X. The first flange 21 has an outer end surface 21A. The outer end surface 21A is a surface facing the first positive direction X1 of outer surfaces of the first flange 21.

The first flange 21 includes a main body 22 and a projecting portion 23. The main body 22 has a substantially rectangular parallelepiped shape with a small thickness in the direction along the central axis X. When viewed toward the first negative direction X2, both edges of the main body 22 in the upward direction Y1 and the downward direction Y2 are parallel to the left-right axis Z. Further, when viewed toward the first negative direction X2, both edges of the main body 22 in the leftward direction Z2 and the rightward direction Z1 are parallel to the up-down axis Y.

The projecting portion 23 projects from an upper surface of the main body 22 toward the upward direction Y1. The projecting portion 23 has a quadrangular truncated pyramid shape in which a dimension in a direction along the left-right axis Z decreases toward the upward direction Y1. The projecting portion 23 is located substantially at a center of the main body 22 in the direction along the left-right axis Z. A dimension of the projecting portion 23 in the direction along the central axis X is the same as a dimension of the main body 22 in the direction along the central axis X. Note that the main body 22 and the projecting portion 23 are integrally molded. That is, there is no clear boundary between the main body 22 and the projecting portion 23 inside the first flange 21.

The second flange 31 and the first flange 21 have a plane-symmetrical shape with respect to a virtual plane passing through a center of the winding core 11 and parallel to the left-right axis Z. That is, the second flange 31 protrudes outward with respect to the winding core 11 in the direction along the up-down axis Y and the direction along the left-right axis Z when viewed from the direction along the central axis X. Then, the second flange 31 has an outer end surface 31A facing the first negative direction X2. The second flange 31 includes a main body 32 and a projecting portion 33. Configurations of the main body 32 and the projecting portion 33 of the second flange 31 are similar to those of the main body 22 and the projecting portion 23 of the first flange 21. That is, the projecting portion 33 projects from an upper surface of the main body 32 toward the upward direction Y1.

The plate core 10F has a rectangular plate shape. A long side of the plate core 10F is parallel to the central axis X. A short side of the plate core 10F is parallel to the left-right axis Z. The plate core 10F is located on the downward direction Y2 side with respect to the drum core 10C. The plate core 10F is connected to both a lower surface of the first flange 21 and a lower surface of the second flange 31. That is, the plate core 10F is bridged between the first flange 21 and the second flange 31. A material of the plate core 10F is the same as a material of the drum core 10C.

The coil component 10 includes a first external electrode 41, a second external electrode 42, a third external electrode 43, and a fourth external electrode 44.

The first external electrode 41 is provided on the first flange 21. That is, the first external electrode 41 is attached to the first flange 21. The first external electrode 41 is located on the leftward direction Z2 side with respect to the central axis X in the first flange 21.

The first external electrode 41 includes a bonding portion AP, a coupling portion BP, a mount part CP, an extension DP, and a joining part EP. Note that the bonding portion AP, the coupling portion BP, the mount part CP, the extension DP, and the joining part EP are integrally molded. That is, there is no clear boundary between these members inside the first external electrode 41.

The bonding portion AP has a substantially plate shape. The bonding portion AP is attached to the outer end surface 21A of the first flange 21 with an adhesive interposed therebetween. The bonding portion AP is a portion of the first external electrode 41 facing the outer end surface 21A of the first flange 21 in the direction along the central axis X.

The coupling portion BP is connected to an end of the bonding portion AP in the upward direction Y1. The coupling portion BP has a substantially plate shape. The coupling portion BP extends from the bonding portion AP toward the upward direction Y1. That is, the coupling portion BP protrudes from the first flange 21 toward the upward direction Y1 when viewed toward the first negative direction X2. Specifically, the coupling portion BP protrudes toward the upward direction Y1 with respect to the projecting portion 23 of the first flange 21. The coupling portion BP is bent by about 90 degrees toward the first negative direction X2 on the way. That is, an end of the coupling portion BP on a side opposite to the bonding portion AP faces the first negative direction X2.

The mount part CP is connected to an end of the coupling portion BP opposite to the bonding portion AP. The mount part CP has a flat plate shape. A main surface of the mount part CP is orthogonal to the up-down axis Y. Further, the mount part CP is a portion of the first external electrode 41 located on the uppermost side in the upward direction Y1. The mount part CP is separated from the projecting portion 23 of the first flange 21 toward the upward direction Y1. That is, there is a gap between the mount part CP and the first flange 21. Note that an upper surface of the mount part CP is the mounting surface facing the substrate when the coil component 10 is mounted on the substrate.

A first end of the extension DP is connected to an end of the mount part CP in the leftward direction Z2. The extension DP has a substantially plate shape. The extension DP extends substantially obliquely from the mount part CP toward the leftward direction Z2 and the downward direction Y2. In other words, the extension DP has a substantially L shape when viewed from the direction along the central axis X.

The joining part EP is connected to a second end of the extension DP. The joining part EP has a substantially plate shape. The joining part EP has a substantially rectangular shape elongated in the direction along the central axis X when viewed toward the downward direction Y2

The joining part EP faces the upper surface of the main body 22 of the first flange 21 along the up-down axis Y. That is, a lower surface of the joining part EP faces an upper surface of the first flange 21. The lower surface of the joining part EP is in contact with the upper surface of the first flange 21. On the other hand, the lower surface of the joining part EP is not fixed to the first flange 21. That is, no adhesive or the like is interposed between the joining part EP and the first flange 21. As described above, when the joining part EP to which ends of wires are connected is located on the upward direction Y1 side of the first flange 21 with respect to the central axis X, it can be said that the first external electrode 41 is located on the upward direction Y1 side of the first flange 21 with respect to the central axis X.

The second external electrode 42 is provided on the first flange 21. That is, the second external electrode 42 is attached to the first flange 21. The second external electrode 42 is located on the rightward direction Z1 side with respect to the central axis X in the first flange 21. The second external electrode 42 and the first external electrode 41 have a plane-symmetrical shape with respect to a virtual plane passing through the central axis X and orthogonal to the left-right axis Z. Therefore, the second external electrode 42 includes a bonding portion AP, a coupling portion BP, a mount part CP, an extension DP, and a joining part EP. Further, the second external electrode 42 is located on the upward direction Y1 side of the first flange 21 with respect to the central axis X.

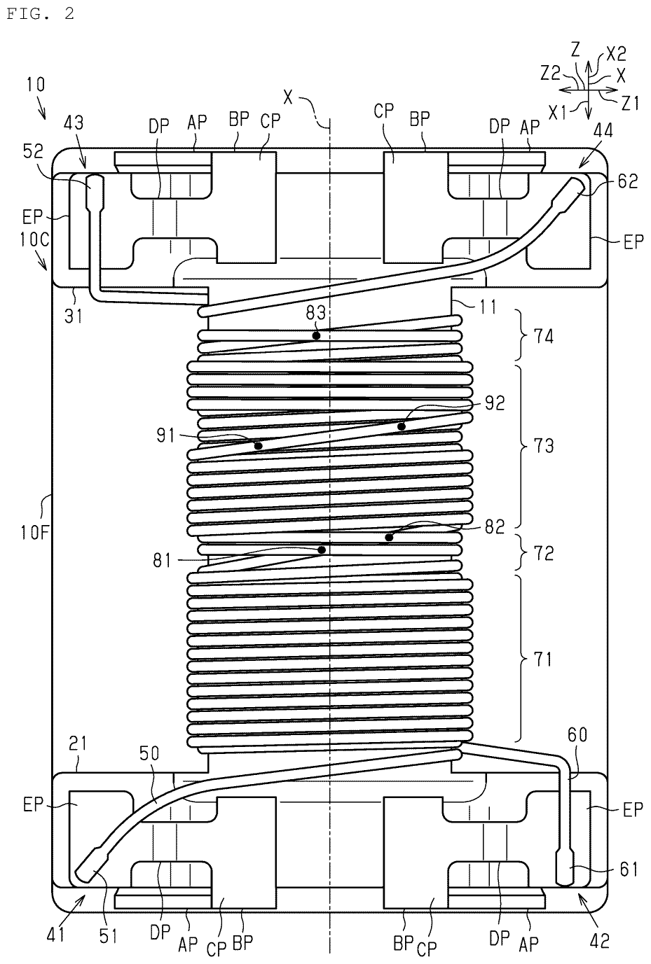

The third external electrode 43 is provided on the second flange 31. That is, the third external electrode 43 is attached to the second flange 31. The third external electrode 43 is located on the leftward direction Z2 side with respect to the central axis X in the second flange 31. That is, the third external electrode 43 faces the first external electrode 41 in the direction along the central axis X. The third external electrode 43 and the first external electrode 41 have a plane-symmetrical shape with respect to the virtual plane passing through the center of the winding core 11 and parallel to the left-right axis Z. Therefore, as shown in FIG. 2, the third external electrode 43 includes a bonding portion AP, a coupling portion BP, a mount part CP, an extension DP, and a joining part EP. Further, the third external electrode 43 is located on the upward direction Y1 side of the second flange 31 with respect to the central axis X.

As shown in FIG. 1, the fourth external electrode 44 is provided on the second flange 31. That is, the fourth external electrode 44 is attached to the second flange 31. The fourth external electrode 44 is located on the rightward direction Z1 side with respect to the central axis X in the second flange 31. That is, the fourth external electrode 44 faces the second external electrode 42 in the direction along the central axis X. The fourth external electrode 44 and the second external electrode 42 have a plane-symmetrical shape with respect to the virtual plane passing through the center of the winding core 11 and parallel to the left-right axis Z. Therefore, as shown in FIG. 2, the fourth external electrode 44 includes a bonding portion AP, a coupling portion BP, a mount part CP, an extension DP, and the joining part EP. Further, the fourth external electrode 44 is located on the upward direction Y1 side of the second flange 31 with respect to the central axis X.

### <First Wire and Second Wire>

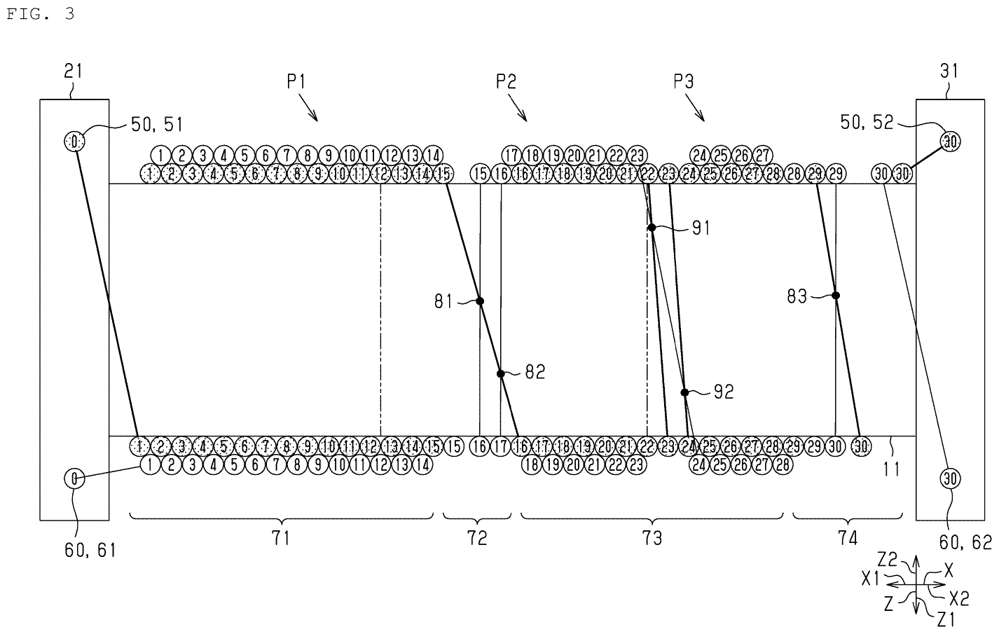

As shown in FIG. 2, the coil component 10 includes a first wire 50 and a second wire 60. Although not shown, the first wire 50 includes a copper wire and an insulating film. The insulating film covers an outer surface of the copper wire. The first wire 50 has a substantially circular shape in a section orthogonal to a direction in which the first wire 50 extends. The first wire 50 has a first end 51 and a second end 52 opposite to the first end 51. Note that in FIGS. 3 to 8, the first wire 50 is colored with dots.

As shown in FIGS. 1 and 2, the first end 51 of the first wire 50 is connected to the joining part EP of the first external electrode 41 by thermocompression bonding. The second end 52 of the first wire 50 is connected to the joining part EP of the third external electrode 43 by thermocompression bonding. Note that the thermocompression bonding is a method of sandwiching a wire between an external electrode and a heated jig, and fixing the wire to the external electrode while melting the wire. As a result of this fixing method, the insulating film is peeled off near a joining portion with the external electrode in the wire, and the copper wire is exposed.

Here, when the first wire 50 is traced from the first end 51 to the second end 52, a portion that first comes into contact with an outer peripheral surface of the winding core 11 is defined as a 1.0 turn portion of the first wire 50. In the first embodiment, the 1.0 turn portion of the first wire 50 is located on a ridge line on the rightward direction Z1 side and the upward direction Y1 side of the winding core 11.

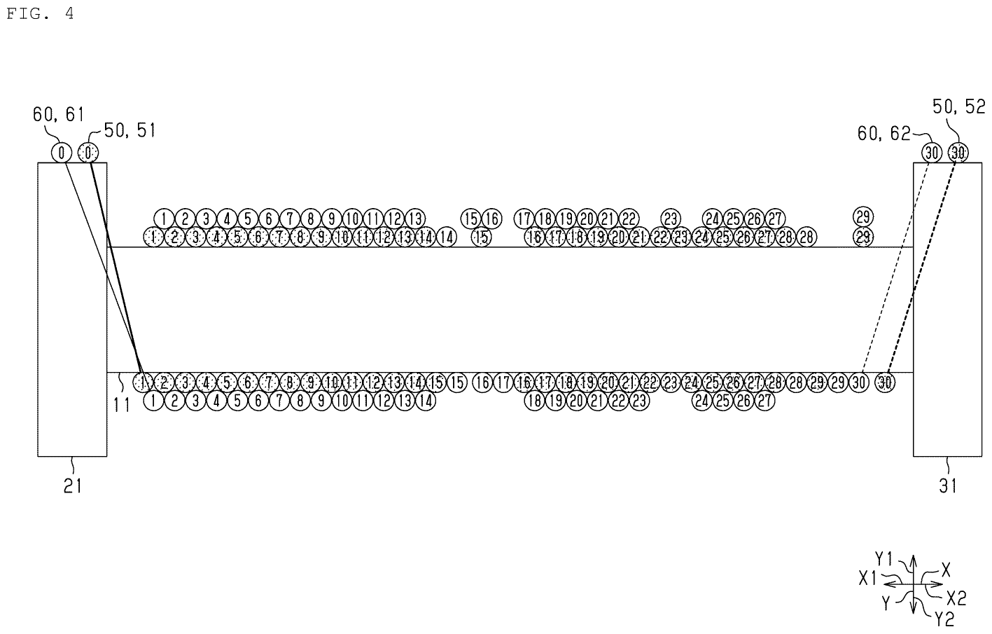

As shown in FIGS. 3 and 4, it is assumed that the number of turns of the first wire 50 increases by 1 every time the first wire 50 makes one turn around the central axis X from the first end 51 toward the second end 52. The first wire 50 is wound around the winding core 11 so as to travel clockwise as the number of turns increases when viewed toward the first negative direction X2. Therefore, for example, when viewed toward the first negative direction X2, a portion that travels 36 degrees about the central axis X from the 1.0 turn portion of the first wire 50 is a 1.1 turn portion of the first wire 50. Note that in FIG. 3, the number of turns of each wire at a ridge line position on the upward direction Y1 side of the winding core 11 is schematically shown. Further, FIG. 4 schematically shows the number of turns of each wire located on the central axis X of the winding core 11 when viewed toward the leftward direction Z2.

As shown in FIG. 3, the first wire 50 is directly wound around the outer peripheral surface of the winding core 11 without interposing the second wire 60 therebetween in the entire circumference. Here, “directly wound” includes not only a state where the wire is in contact with an outer peripheral side of the winding core 11 but also a state where the wire is wound around the outer peripheral surface of the winding core 11 without interposing another wire therebetween also when the wire is in a floating state.

A first turn of the first wire 50 indicates a section from the 1.0 turn portion to immediately before a 2.0 turn portion of the first wire 50. The same applies to the second wire 60. In addition, a last turn of the first wire 50 is a turn including a portion that finally comes into contact with the outer peripheral side of the winding core 11 when the first wire 50 is traced from the first end 51 to the second end 52. Note that in FIGS. 3 and 4, a portion located on the first end side from 1.0 turn of each wire is shown as 0 turn.

As shown in FIG. 2, the second wire 60 has the same configuration as the first wire 50. That is, the second wire 60 includes the copper wire and the insulating film. The second wire 60 has a first end 61 and a second end 62 opposite to the first end 61.

The first end 61 of the second wire 60 is connected to the joining part EP of the second external electrode 42 by thermocompression bonding. The second end 62 of the second wire 60 is connected to the joining part EP of the fourth external electrode 44 by thermocompression bonding.

Here, as shown in FIGS. 3 and 4, when the second wire 60 is traced from the first end 61 to the second end 62, a portion where an angular position about the central axis X first coincides with an angular position of the 1.0 turn portion of the first wire 50 is defined as a 1.0 turn portion of the second wire 60. That is, in the first embodiment, the 1.0 turn portion of the second wire 60 is located on a straight line connecting a ridge line on the rightward direction Z1 side and the upward direction Y1 side of the winding core 11 and the central axis X when viewed toward the direction along the central axis X.

It is assumed that the number of turns of the second wire 60 increases by 1 every time the second wire 60 makes one turn around the central axis X from the first end 61 toward the second end 62. The second wire 60 is wound around the winding core 11 so as to travel clockwise as the number of turns increases when viewed toward the first negative direction X2. That is, the second wire 60 is wound in the same direction as the first wire 50. Then, a part of the second wire 60 is wound around the winding core 11 from outside the first wire 50. In other words, a part of the second wire 60 is in contact with an outer peripheral surface of the first wire 50 on a side opposite to a surface facing the central axis X. In addition, a last turn of the second wire 60 is a turn including a portion that finally comes into contact with the outer peripheral surface of the winding core 11 last when the second wire 60 is traced from the first end 61 to the second end 62.

### <Winding Form of First Wire and Second Wire>

As shown in FIG. 3, in the first embodiment, the last turn of the first wire 50 is a 30th turn. In the first embodiment, the last turn of the second wire 60 is a 30th turn.

As described above, the first wire 50 is directly wound around the outer peripheral surface of the winding core 11 without interposing the second wire 60 therebetween in the entire circumference. In the first wire 50, from the first turn to the middle of the 15th turn, the turns are in contact with each other in the direction along the central axis X. On the other hand, a 15.0 turn portion and a 16.0 turn portion of the first wire 50 are separated from each other in the direction along the central axis X. Then, from the 16th turn to the 28th turn of the first wire 50, the turns are in contact with each other in the direction along the central axis X.

A 28.0 turn portion of the first wire 50 and a 29.0 turn portion of the first wire 50 are in contact with each other in the direction along the central axis X. On the other hand, the 28th turn and the 29th turn of the first wire 50 are separated from each other in the direction along the central axis X on a ridge line on the upward direction Y1 side and the leftward direction Z2 side of the winding core 11. Further, the 30th turn of the first wire 50 is separated from the 29th turn of the first wire 50 in the direction along the central axis X.

As shown in FIGS. 2 and 3, the second wire 60 includes a first wound portion 71, a second wound portion 72, a third wound portion 73, and a fourth wound part 74.

As shown in FIG. 3, the first wound portion 71 is a portion of the second wire 60 wound around an outer peripheral side of the first wire 50 over a plurality of turns. In the first embodiment, the first wound portion 71 is a portion from the first turn to the middle of the 14th turn of the second wire 60. That is, the first wound portion 71 is a portion of the second wire 60 from a portion riding on the outer peripheral side of the first wire 50 to a portion immediately before being directly wound around the outer peripheral surface of the winding core 11.

Here, I is a positive integer. Further, a groove formed by two adjacent turns of the wire is defined as a valley of the wire. At this time, in the first wound portion 71, the I-th turn of the second wire 60 is located between the I-th turn of the first wire 50 and the (I+1)-th turn of the first wire 50. Specifically, for example, the first turn of the second wire 60 is located at a valley between the first turn of the first wire 50 and the second turn of the first wire 50.

The second wound portion 72 is located on the second flange 31 side with respect to the first wound portion 71 in the direction along the central axis X. The second wound portion 72 is a portion of the second wire 60, at least a part of which is wound around the outer peripheral surface of the winding core 11. Specifically, the second wound portion 72 is a portion of the second wire 60 from the middle of the 14th turn to the middle of the 17th turn. A 15.0 turn portion, a 16.0 turn portion, and a 17.0 turn portion of the second wire 60 are directly wound around the outer peripheral surface of the winding core 11 between the 15.0 turn portion and the 16.0 turn portion of the first wire 50.

Then, the second wire 60 intersects the 15th turn of the first wire 50 in the 15th and 16th turns of the second wire 60. The term “intersect” as used herein means that when one wire is traced from the first end to the second end, the one wire in the same layer as the other wire once rides on the outer peripheral side of the other wire and reaches the same layer as the other wire again.

Specifically, the 15th turn of the second wire 60 has a first intersection 81 intersecting the 15th turn of the first wire 50. Further, the 16th turn of the second wire 60 has a second intersection 82 intersecting the 15th turn of the first wire 50.

That is, in the second wound portion 72, when the second wire 60 is traced from the first end 61 to the second end 62, the second wire 60 has the first intersection 81 and the second intersection 82 intersecting one specific turn of the first wire 50 within a range where the second wire 60 is wound by two turns. Note that in the present embodiment, as shown in FIG. 2, when viewed toward a direction orthogonal to the central axis X of the winding core 11, a portion where center lines of the wires overlap each other is referred to as an “intersection”.

As shown in FIG. 3, when the second wire 60 is traced from the first end 61 to the second end 62, the first intersection 81 is a portion crossing the first wire 50 from the second flange 31 side to the first flange 21 side in the direction along the central axis X. Similarly, the second intersection 82 is a portion where the second wire 60 crosses the first wire 50 from the second flange 31 side to the first flange 21 side in the direction along the central axis X.

The first intersection 81 and the second intersection 82 are located on the outer peripheral surface of the winding core 11 facing the upward direction Y1. That is, the first intersection 81, the second intersection 82, and the joining part EP of the first external electrode 41 are located on the mounting surface side. Further, in other words, the first intersection 81 and the second intersection 82 are located on the outer peripheral surface of the winding core 11 on the upward direction Y1 side with respect to the central axis X. Therefore, the first intersection 81 is located at or after an about 15.75 turn portion in the 15th turn. Similarly, the second intersection 82 is located at or after an about 16.75 turn portion in the 16th turn.

The second wire 60 rides on the outer peripheral side of the first wire 50 from the outer peripheral surface of the winding core 11 in the middle of the 17th turn. Specifically, the second wire 60 rides on the outer peripheral side of the first wire 50 within a range of 17.5 turns or more and less than 18.0 turns (i.e., from 17.5 turns to less than 18.0 turns). Note that a portion of the second wire 60 riding on the outer peripheral side of the first wire 50 in the 17th turn is a valley portion between the 16th turn of the first wire 50 and the 16th turn of the second wire 60.

The third wound portion 73 is located on the second flange 31 side with respect to the second wound portion 72 in the direction along the central axis X. The third wound portion 73 is a portion of the second wire 60 wound around the outer peripheral side of the first wire 50 over a plurality of turns. In the first embodiment, the third wound portion 73 is a portion from the middle of the 17th turn to the middle of the 28th turn of the second wire 60. That is, the third wound portion 73 is a portion of the second wire 60 from a portion riding on the outer peripheral side of the first wire 50 to a portion immediately before being directly wound around the outer peripheral surface of the winding core 11.

The 17th turn of the second wire 60 is located at a valley between the 16th turn of the second wire 60 and the 16th turn of the first wire 50 on the ridge line on the upward direction Y1 side and the leftward direction Z2 side of the winding core 11. Then, from the 18th turn of the second wire 60 to the middle of the 23rd turn of the second wire 60, the I-th turn of the second wire 60 is located at a valley between the (I−2)-th turn of the first wire 50 and the (I−1)-th turn of the first wire 50.

Then, the second wire 60 crosses the 22nd turn and the 23rd turn of the first wire 50 at the 23rd turn of the second wire 60. The term “cross” as used herein means that one wire crosses the other wire without reaching the same layer as the other wire. Since a crossing exists as described above, the second wire 60 has a portion contacting the 22nd turn, a portion contacting the 23rd turn, and a portion contacting the 24th turn of the first wire 50 within a range of one turn.

Specifically, the 23rd turn of the second wire 60 has a first crossing 91 crossing the 22nd turn of the first wire 50. Further, the 23rd turn of the second wire 60 has a second crossing 92 crossing the 23rd turn of the first wire 50. Note that in the present embodiment, as shown in FIG. 2, when viewed toward the direction orthogonal to the central axis X of the winding core 11, a portion where the center lines of the wires overlap each other is referred to as a “crossing”.

As shown in FIG. 3, when the second wire 60 is traced from the first end 61 to the second end 62, the first crossing 91 is a portion crossing the first wire 50 from the first flange 21 side to the second flange 31 side in the direction along the central axis X. Similarly, the second intersection 82 is a portion crossing the first wire 50 from the first flange 21 side to the second flange 31 side in the direction along the central axis X.

A 24.0 turn portion of the second wire 60 is located at a valley between the 24th turn of the first wire 50 and the 25th turn of the first wire 50. Then, from the 24th turn of the second wire 60 to the middle of the 28th turn of the second wire 60, the I-th turn of the second wire 60 is located at a valley between the I-th turn of the first wire 50 and the (I+1)-th turn of the first wire 50.

The second wire 60 moves from the outer peripheral side of the first wire 50 onto the outer peripheral surface of the winding core 11 in the middle of the 28th turn. Specifically, as shown in FIG. 4, the second wire 60 moves onto the outer peripheral surface of the winding core 11 within a range of 28.0 turns or more and less than 28.5 turns (i.e., from 28.0 turns to less than 28.5 turns).

As shown in FIG. 3, the fourth wound part 74 is located on the second flange 31 side with respect to the third wound portion 73 in the direction along the central axis X. The fourth wound part 74 is a portion of the second wire 60, at least a part of which is wound around the outer peripheral side of the winding core 11. Specifically, the fourth wound part 74 is a portion of the second wire 60 from the middle of the 28th turn to the 30th turn.

The 28th turn of the second wire 60 is directly wound around the outer peripheral surface of the winding core 11 between the 28th turn of the first wire 50 and the 29th turn of the first wire 50 on the ridge line on the upward direction Y1 side and the leftward direction Z2 side of the winding core 11. Then, a 29.0 turn portion of the second wire 60 is directly wound around the outer peripheral surface of the winding core 11 between the 29.0 turn portion and a 30.0 turn portion of the first wire 50. Then, the 29th turn of the second wire 60 is directly wound around the outer peripheral surface of the winding core 11 between the 29th turn of the first wire 50 and the 30th turn of the first wire 50 on the ridge line on the upward direction Y1 side and the leftward direction Z2 side of the winding core 11.

Then, the second wire 60 intersects the 29th turn of the first wire 50 in the 29th turn of the second wire 60. Specifically, the 29th turn of the second wire 60 has a third intersection 83 intersecting the 29th turn of the first wire 50. That is, a turn one turn before the last turn of the second wire 60 has the third intersection 83 intersecting a turn one turn before the last turn of the first wire 50. In other words, the second wire 60 has the third intersection 83 intersecting the first wire 50 in a turn different from a turn having the first intersection 81 and a turn having the second intersection 82.

When the second wire 60 is traced from the first end 61 to the second end 62, the third intersection 83 is a portion crossing the first wire 50 from the second flange 31 side to the first flange 21 side in the direction along the central axis X. Further, the third intersection 83 is located on a surface facing the upward direction Y1 on the outer peripheral surface of the winding core 11. In other words, the third intersection 83 is located on the upward direction Y1 side of the winding core 11 with respect to the central axis X.

The 30.0 turn portion of the second wire 60 is directly wound around the outer peripheral surface of the winding core 11 between the 29.0 turn portion and the 30.0 turn portion of the first wire 50. More specifically, the 30.0 turn portion of the second wire 60 is directly wound around the outer peripheral surface of the winding core 11 between the 29.0 turn portion of the second wire 60 and the 30.0 turn portion of the first wire 50. Further, a portion directly wound around the outer peripheral surface of the winding core 11 in the 30th turn, which is the last turn of the second wire 60, is located between the 29th turn of the second wire 60 and the 30th turn of the first wire 50. Furthermore, the 30th turn, which is the last turn of the second wire 60, is located between the 29th turn of the first wire 50 and the 30th turn of the first wire 50.

### <Positional Relationship of Intersection>

Here, it is assumed that N is an integer of 3 or more, and a specific one turn of the first wire 50 is an N-th turn of the first wire 50. As described above, the first intersection 81 and the second intersection 82 of the second wire 60 intersect the 15th turn of the first wire 50. Then, the first intersection 81 is the 15th turn, and the second intersection 82 is the 16th turn. Therefore, when N is 15, the first intersection 81 is the N-th turn of the second wire 60. Further, the second intersection 82 is the (N+1)-th turn of the second wire 60.

When the second wire 60 is traced from the first end 61 to the second end 62 at the first crossing 91 and the second crossing 92, the 23rd turn of the second wire 60 crosses the first wire 50 from the first flange 21 side to the second flange 31 side in the direction along the central axis X. Therefore, the second wire 60 has a portion crossing the first wire 50 from the first flange 21 side to the second flange 31 side in the direction along the central axis X in a turn after the first intersection 81 and the second intersection 82.

The last turn of the first wire 50 is the 30th turn. Then, the first intersection 81 and the second intersection 82 of the second wire 60 intersect each other in the 15th turn of the first wire 50. Therefore, the last turn of the first wire 50 is the (2×N)-th turn. Similarly, the last turn of the second wire 60 is the (2×N)-th turn.

As shown in FIG. 3, in the 15th turn of the second wire 60, the wire is directly wound around the outer peripheral surface of the winding core 11 except for the vicinity of the first intersection 81. Then, as described above, the first intersection 81 is located at or after the about 15.75 turn portion in the 15th turn. Accordingly, the second wire 60 is wound around the outer peripheral surface of the winding core 11 by 0.5 turns or more, specifically 0.75 turns or more in the turn having the first intersection 81.

In the 16th turn of the second wire 60, the wire is directly wound around the outer peripheral surface of the winding core 11 except for the vicinity of the second intersection 82. Then, as described above, the second intersection 82 is located at or after the about 16.75 turn portion in the 16th turn. Accordingly, the second wire 60 is wound around the outer peripheral surface of the winding core 11 by 0.5 turns or more, specifically 0.75 turns or more in the turn having the second intersection 82.

As shown in FIG. 3, it is assumed that the winding core 11 is equally divided into three regions in the direction along the central axis X. Then, the three regions are defined as a first region P1, a second region P2, and a third region P3 in this order from the first flange 21 side. At this time, the first intersection 81 and the second intersection 82 are located in the second region P2. That is, the first intersection 81 and the second intersection 82 are located in the central second region P2 among the three regions. Note that in FIG. 3, boundaries of the first region P1, the second region P2, and the third region P3 are virtually shown by two-dot chain lines.

### <Mode Conversion Characteristics>

For the coil component 10 of the first embodiment and the coil component of a comparative example, Ssd12 was measured as an index related to mode conversion characteristics. The number of turns of each wire in the coil component of the comparative example is the same as that of the coil component 10 of the first embodiment, and is 30 turns. The coil component of the comparative example includes the first wound portion, the second wound portion, the third wound portion, and the fourth wound part. Further, the coil component of the comparative example has the first intersection but does not have the second intersection. That is, the second wound portion in the coil component of the comparative example is a portion from the middle of the 14th turn to the middle of the 16th turn of the second wire. Further, the third wound portion in the coil component of the comparative example is a portion from the middle of the 16th turn to the middle of the 28th turn of the second wire. Note that the first wound portion and the fourth wound part of the comparative example are respectively wound in the same manner as the first wound portion 71 and the fourth wound part 74 of the coil component 10 of the first embodiment. The material of the drum core and the material of the top plate in the coil component of the comparative example are the same as those of the coil component 10 of the first embodiment. That is, in the coil component 10 of the first embodiment, a length of a portion wound around the winding core 11 in the second wire 60 is longer than that of the coil component of the comparative example by an amount of being directly wound around the outer peripheral surface of the winding core 11 at the second intersection 82. In other words, in the coil component 10 of the first embodiment, a difference in the length of the portion wound around the winding core 11 between the wires is shorter than that in the coil component of the comparative example.

In measurement, the coil component 10 of the first embodiment and the coil component of the comparative example were mounted on a 3 port substrate compliant with Open Alliance. Then, after SOLT calibration was performed on each coil component, the Ssd12 of each coil component was measured. Then, measurement results acquired from the coil components, that is, an average value of 20 measurement results was taken as a representative value of the measurement results.

In the coil component 10 of the first embodiment, the Ssd12 was-82.2 dB when a measurement frequency was 1.6 MHz. Further, in the coil component of the comparative example, the Ssd12 was-84.7 dB when the measurement frequency was 1.6 MHz. That is, it has been found that the value of the Ssd12 can be suppressed as the difference in the length of the portion wound around the winding core 11 between the wires is shorter.

### Effects of First Embodiment

(1-1) According to the first embodiment, the second wire 60 has the first intersection 81 and the second intersection 82 intersecting the specific one turn of the first wire 50 within a range where the second wire 60 is wound by two turns. In other words, the second wire 60 sufficiently has a portion directly wound around the outer peripheral surface of the winding core 11. According to this configuration, a difference between a length of the second wire 60 wound around the winding core 11 and a length of the first wire 50 wound around the winding core 11 can be reduced. Therefore, according to the above configuration, a difference in DC resistance between the second wire 60 and the first wire 50 can be reduced. As a result, it is possible to suppress adverse effects on characteristics required as the coil component. Specifically, according to the above configuration, the value of the Ssd12 can be suppressed by reducing the difference in DC resistance between the second wire 60 and the first wire 50.

(1-2) In the first embodiment, the second wire 60 is wound around the outer peripheral surface of the winding core 11 by 0.5 turns or more in the turn having the first intersection 81. Further, the second wire 60 is wound around the outer peripheral surface of the winding core 11 by 0.5 turns or more in the turn having the second intersection 82. That is, the second wire 60 has a portion wound around the outer peripheral surface of the winding core 11 without interposing the first wire 50 therebetween in the second wound portion 72, which is 1.0 turn or more in total. That is, according to this configuration, the length of the second wire 60 wound around the winding core 11 and the length of the first wire 50 wound around the winding core 11 are sufficiently provided. Further, according to this configuration, as compared with a configuration in which only one of the first intersection 81 and the second intersection 82 exists, winding disturbance of the second wire 60 can be suppressed in the vicinity of the intersection.

(1-3) In the first embodiment, it is assumed that the second wire 60 is traced from the first end 61 to the second end 62. At this time, the first intersection 81 and the second intersection 82 are portions crossing the first wire 50 from the second flange 31 side to the first flange 21 side in the direction along the central axis X. Further, in the first embodiment, the second wire 60 has the first crossing 91 and the second crossing 92. That is, when the second wire 60 is traced from the first end 61 to the second end 62 in turns after the first intersection 81 and the second intersection 82, the second wire 60 crosses the first wire 50 from the first flange 21 side to the second flange 31 side in the direction along the central axis X. According to this configuration, it is possible to adjust a balance of stray capacitances before and after the first intersection 81 and the second intersection 82 and before and after the first crossing 91 and the second crossing 92, to improve electrical characteristics.

(1-4) In the first embodiment, the first intersection 81 is the 15th turn of the second wire 60, and the second intersection 82 is the 16th turn of the second wire 60. Further, the first intersection 81 and the second intersection 82 intersect the 15th turn of the first wire 50. That is, assuming that a specific one turn of the first wire 50 is the N-th turn of the first wire 50, the first intersection 81 is the N-th turn of the second wire 60, and the second intersection 82 is the (N+1)-th turn of the second wire 60. According to this configuration, the numbers of turns of the first wire 50 and the second wire 60 are not greatly different from each other at these intersections. Therefore, the stray capacitances at the first intersection 81 and the second intersection 82 can be suppressed.

(1-5) In the first embodiment, the first turn of the second wire 60 is located between the first turn of the first wire 50 and the second turn of the first wire 50. In other words, the second wire 60 is located on the second flange 31 side with respect to the same turn of the first wire 50 in the direction along the central axis X. Further, the first intersection 81 and the second intersection 82 cross the first wire 50 from the second flange 31 side to the first flange 21 side in the direction along the central axis X when the second wire 60 is traced from the first end 61 to the second end 62. Therefore, in the turn after the first intersection 81 and the second intersection 82, the second wire 60 is located on the first flange 21 side with respect to the same turn of the first wire 50 in the direction along the central axis X. In this manner, directions of displacement of the second wire 60 with respect to the first wire 50 are switched before and after the first intersection 81 and the second intersection 82. Thus, in the coil component 10 as a whole, at least a part of the stray capacitance in turns before the first intersection 81 and the second intersection 82 can be offset by the stray capacitance in the turns after the first intersection 81 and the second intersection 82.

(1-6) In the first embodiment, the last turn of the first wire 50 is the 30th turn. The last turn of the second wire 60 is the 30th turn. That is, the second wire 60 intersects the first wire 50 in the 15th turn including a center of the second wire 60 among turns wound around the winding core 11. As described above, since the intersection is located substantially at a center of total turns, it is possible to reduce a bias of the stray capacitance when the second wire 60 is viewed as a whole.

(1-7) In the first embodiment, when the winding core 11 is equally divided into three regions in the direction along the central axis X, the first intersection 81 and the second intersection 82 are located in the central second region P2. As described above, since the intersections are concentrated in a central portion of the winding core 11, it is easy to visually recognize the intersections. For example, when compared with a coil component having no intersection, the coil component 10 of the first embodiment can be determined by visually recognizing the second region P2.

### Second Embodiment

Hereinafter, the second embodiment of the coil component will be described. Note that in the coil component 10 of the second embodiment, configurations of the drum core 10C, the plate core 10F, and the first external electrode 41 to the fourth external electrode 44 are the same as those of the first embodiment. Hereinafter, a winding form of the first wire 50 and the second wire 60 having a configuration different from that of the first embodiment will be described.

### <Winding Form of First Wire and Second Wire>

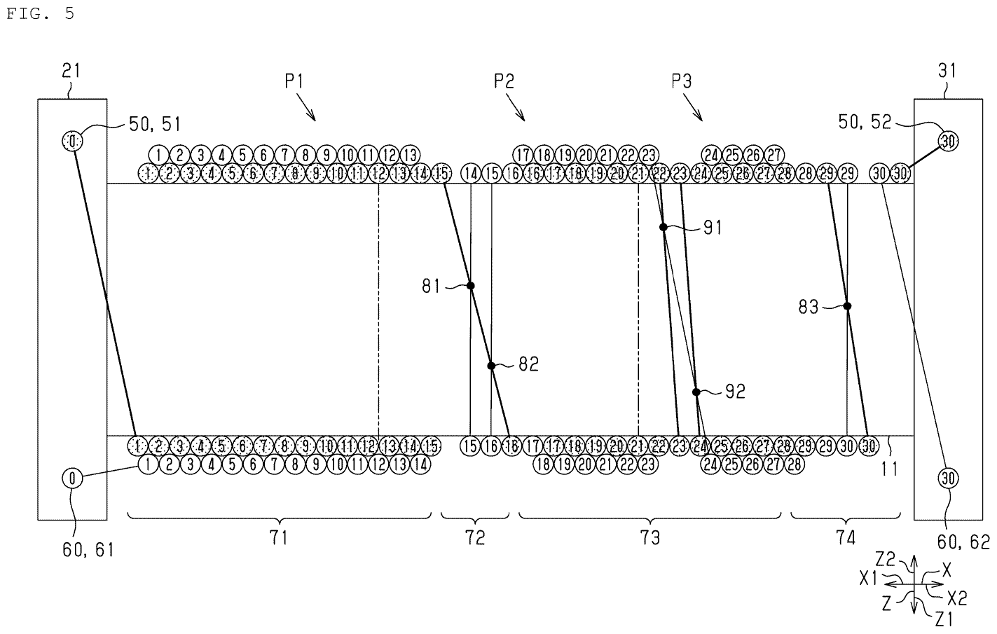

As shown in FIG. 5, in the second embodiment, the last turn of the first wire 50 is the 30th turn. In the second embodiment, the last turn of the second wire 60 is the 30th turn.

The first wire 50 is directly wound around the outer peripheral surface of the winding core 11 without interposing the second wire 60 therebetween in the entire circumference. In the first wire 50, from the first turn to the middle of the 15th turn, the turns are in contact with each other in the direction along the central axis X. On the other hand, a 15.0 turn portion and a 16.0 turn portion of the first wire 50 are separated from each other in the direction along the central axis X. Then, from the 17th turn to the 28th turn of the first wire 50, the turns are in contact with each other in the direction along the central axis X.

A 28.0 turn portion of the first wire 50 and a 29.0 turn portion of the first wire 50 are in contact with each other in the direction along the central axis X. On the other hand, the 28th turn and the 29th turn of the first wire 50 are separated from each other in the direction along the central axis X on a ridge line on the upward direction Y1 side and the leftward direction Z2 side of the winding core 11. Further, the 30th turn of the first wire 50 is separated from the 29th turn of the first wire 50 in the direction along the central axis X.

The second wire 60 includes the first wound portion 71, the second wound portion 72, the third wound portion 73, and the fourth wound part 74.

The first wound portion 71 is a portion of the second wire 60 wound around the outer peripheral side of the first wire 50 over a plurality of turns. In the second embodiment, the first wound portion 71 is the portion from the first turn to the middle of the 14th turn of the second wire 60. That is, the first wound portion 71 is a portion of the second wire 60 from a portion riding on the outer peripheral side of the first wire 50 to a portion immediately before being directly wound around the outer peripheral surface of the winding core 11.

Here, I is a positive integer. Further, a groove formed by two adjacent turns of the wire is defined as a valley of the wire. At this time, in the first wound portion 71, the I-th turn of the second wire 60 is located between the I-th turn of the first wire 50 and the (I+1)-th turn of the first wire 50. Specifically, for example, the first turn of the second wire 60 is located at the valley between the first turn of the first wire 50 and the second turn of the first wire 50.

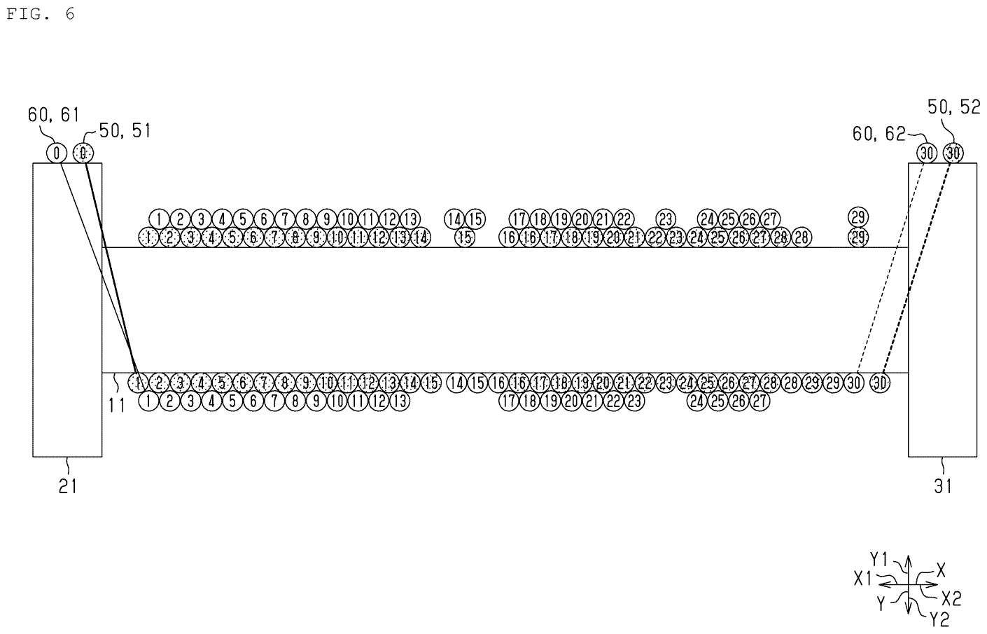

The second wire 60 moves from the outer peripheral side of the first wire 50 onto the outer peripheral surface of the winding core 11 in the middle of the 14th turn. Specifically, as shown in FIG. 6, the second wire 60 moves onto the outer peripheral surface of the winding core 11 within a range of 14.0 turns or more and less than 14.5 turns (i.e., from 14.0 turns to less than 14.5 turns).

As shown in FIG. 5, the second wound portion 72 is located on the second flange 31 side with respect to the first wound portion 71 in the direction along the central axis X. The second wound portion 72 is a portion of the second wire 60, at least a part of which is wound around the outer peripheral side of the winding core 11. Specifically, the second wound portion 72 is a portion of the second wire 60 from the middle of the 14th turn to the middle of the 17th turn.

The 14th turn of the second wire 60 is directly wound around the outer peripheral surface of the winding core 11 between the 15th turn of the second wire 60 and the 16th turn of the first wire 50 on the ridge line on the upward direction Y1 side and the leftward direction Z2 side of the winding core 11. Then, the 15.0 turn portion and the 16.0 turn portion of the second wire 60 are directly wound around the outer peripheral surface of the winding core 11 between the 15.0 turn portion and the 16.0 turn portion of the first wire 50.

Then, the second wire 60 intersects the 15th turn of the first wire 50 in the 14th and 15th turns of the second wire 60. The term “intersect” used herein is the same as the term “intersect” in the first embodiment.

Specifically, the 14th turn of the second wire 60 has a first intersection 81 intersecting the 15th turn of the first wire 50. Further, the 15th turn of the second wire 60 has a second intersection 82 intersecting the 15th turn of the first wire 50.

That is, in the second wound portion 72, when the second wire 60 is traced from the first end 61 to the second end 62, the second wire 60 has the first intersection 81 and the second intersection 82 intersecting one specific turn of the first wire 50 within a range where the second wire 60 is wound by two turns. Note that also in the present embodiment, when viewed toward the direction orthogonal to the central axis X of the winding core 11, the portion where the center lines of the wires overlap each other is referred to as the “intersection”.

When the second wire 60 is traced from the first end 61 to the second end 62, the first intersection 81 is a portion crossing the first wire 50 from the second flange 31 side to the first flange 21 side in the direction along the central axis X. Similarly, the second intersection 82 is a portion where the second wire 60 crosses the first wire 50 from the second flange 31 side to the first flange 21 side in the direction along the central axis X.

The first intersection 81 and the second intersection 82 are located on the outer peripheral surface of the winding core 11 facing the upward direction Y1. In other words, the first intersection 81 and the second intersection 82 are located on the outer peripheral surface of the winding core 11 on the upward direction Y1 side with respect to the central axis X. Therefore, the first intersection 81 is located at or after an about 14.75 turn portion in the 14th turn. Similarly, the second intersection 82 is located at or after an about 15.75 turn portion in the 15th turn.

The 17.0 turn portion of the second wire 60 is directly wound around the outer peripheral surface of the winding core 11 between the 16.0 turn portion and the 17.0 turn portion of the first wire 50. Then, the second wire 60 rides on the outer peripheral side of the first wire 50 from the outer peripheral surface of the winding core 11 in the middle of the 17th turn. Specifically, as shown in FIG. 6, the second wire 60 rides on the outer peripheral side of the first wire 50 within a range of 17.0 turns or more and less than 17.5 turns (i.e., from 17.0 turns to less than 17.5 turns). Note that as shown in FIG. 5, the portion of the second wire 60 riding on the outer peripheral side of the first wire 50 in the 17th turn is the valley portion between the 16th turn of the first wire 50 and the 16th turn of the second wire 60.

The third wound portion 73 in the second embodiment has the same configuration as the third wound portion 73 in the first embodiment. That is, the 23rd turn of the second wire 60 has a first crossing 91 crossing the 22nd turn of the first wire 50. Further, the 23rd turn of the second wire 60 has a second crossing 92 crossing the 23rd turn of the first wire 50.

The fourth wound part 74 in the second embodiment has the same configuration as the fourth wound part 74 in the first embodiment. That is, the 29th turn of the second wire 60 has a third intersection 83 intersecting the 29th turn of the first wire 50. The third intersection 83 is a portion intersecting the turn one turn before the last turn of the first wire 50 in the turn one turn before the last turn of the second wire 60. Further, a portion directly wound around the outer peripheral surface of the winding core 11 in the 30th turn, which is the last turn of the second wire 60, is located between the 29th turn of the second wire 60 and the 30th turn of the first wire 50. Furthermore, the 30th turn, which is the last turn of the second wire 60, is located between the 29th turn, which is the turn one turn before the last turn, and the 30th turn, which is the last turn of the first wire 50.

### <Positional Relationship of Intersection>

Here, it is assumed that N is an integer of 3 or more, and a specific one turn of the first wire 50 is an N-th turn of the first wire 50. As described above, the first intersection 81 and the second intersection 82 of the second wire 60 intersect the 15th turn of the first wire 50. Then, the first intersection 81 is the 14th turn, and the second intersection 82 is the 15th turn. Therefore, when N is 15, the first intersection 81 is the (N−1)-th turn of the second wire 60. Further, the second intersection 82 is the N-th turn of the second wire 60.

When the second wire 60 is traced from the first end 61 to the second end 62 at the first crossing 91 and the second crossing 92, the 23rd turn of the second wire 60 crosses the first wire 50 from the first flange 21 side to the second flange 31 side in the direction along the central axis X. Therefore, the second wire 60 has a portion crossing the first wire 50 from the first flange 21 side to the second flange 31 side in the direction along the central axis X in a turn after the first intersection 81 and the second intersection 82.

The last turn of the first wire 50 is the 30th turn. Then, the first intersection 81 and the second intersection 82 of the second wire 60 intersect each other in the 15th turn of the first wire 50. Therefore, the last turn of the first wire 50 is the (2×N)-th turn. Similarly, the last turn of the second wire 60 is the (2×N)-th turn.

As described above, the turn one turn before the last turn of the second wire 60 has the third intersection 83 intersecting the turn one turn before the last turn of the first wire 50. That is, in the second embodiment, a turn one turn before the (2×N)-th turn of the second wire 60 has the third intersection 83 that intersects with a turn one turn before the (2×N)-th turn of the first wire 50.

In the 14th turn of the second wire 60, the wire is directly wound around the outer peripheral surface of the winding core 11 except for the vicinity of the first intersection 81 and the vicinity of a 14.0 turn portion. Then, as described above, the first intersection 81 is located at or after the about 14.75 turn portion in the 14th turn. Therefore, the second wire 60 is wound around the outer peripheral surface of the winding core 11 by 0.5 turns or more in the turn having the first intersection 81.

In the 15th turn of the second wire 60, the wire is directly wound around the outer peripheral surface of the winding core 11 except for the vicinity of the second intersection 82. Then, as described above, the second intersection 82 is located at or after the about 15.75 turn portion in the 15th turn. Therefore, the second wire 60 is wound around the outer peripheral surface of the winding core 11 by 0.5 turns or more in the turn having the second intersection 82.

As shown in FIG. 5, it is assumed that the winding core 11 is equally divided into three regions in the direction along the central axis X. Then, the three regions are defined as a first region P1, a second region P2, and a third region P3 in this order from the first flange 21 side. At this time, the first intersection 81 and the second intersection 82 are located in the second region P2. That is, the first intersection 81 and the second intersection 82 are located in the central second region P2 among the three regions. Note that in FIG. 5, boundaries of the first region P1, the second region P2, and the third region P3 are virtually shown by two-dot chain lines.

### Effects of Second Embodiment

In the second embodiment, the following effects can be obtained in addition to the same effects as effects (1-1) to (1-3) and (1-5) to (1-7) of the first embodiment.

(2-1) In the second embodiment, the first intersection 81 is the 14th turn of the second wire 60, and the second intersection 82 is the 15th turn of the second wire 60. Further, the first intersection 81 and the second intersection 82 intersect the 15th turn of the first wire 50. That is, assuming that a specific one turn of the first wire 50 is the N-th turn of the first wire 50, the first intersection 81 is the (N−1)-th turn of the second wire 60, and the second intersection 82 is the N-th turn of the second wire 60. According to this configuration, the numbers of turns of the first wire 50 and the second wire 60 are not greatly different from each other at these intersections. Therefore, the stray capacitances at the first intersection 81 and the second intersection 82 can be suppressed.

(2-2) In the second embodiment, the third intersection 83 is a portion intersecting the turn one turn before the (2×N)-th turn of the first wire 50 in the turn one turn before the (2×N)-th turn of the second wire 60. That is, the third intersection 83 is located on the second flange 31 side from the first intersection 81 and the second intersection 82. Further, the first intersection 81 is located on the first flange 21 side from the 15th turn including the center of the second wire. The third intersection 83 is located on the second flange 31 side from the 15th turn including the center of the second wire 60. Therefore, according to the above configuration, it is possible to suppress the bias of the stray capacitance of the coil component 10 when the coil component 10 is viewed as a whole.

### Third Embodiment

Hereinafter, a third embodiment of the coil component will be described. Note that in the coil component 10 of the third embodiment, the configurations of the drum core 10C, the plate core 10F, and the first external electrode 41 to the fourth external electrode 44 are the same as those of the first embodiment. Hereinafter, the winding form of the first wire 50 and the second wire 60 having a configuration different from that of the first embodiment and the second embodiment will be described.

### <Winding Form of First Wire and Second Wire>

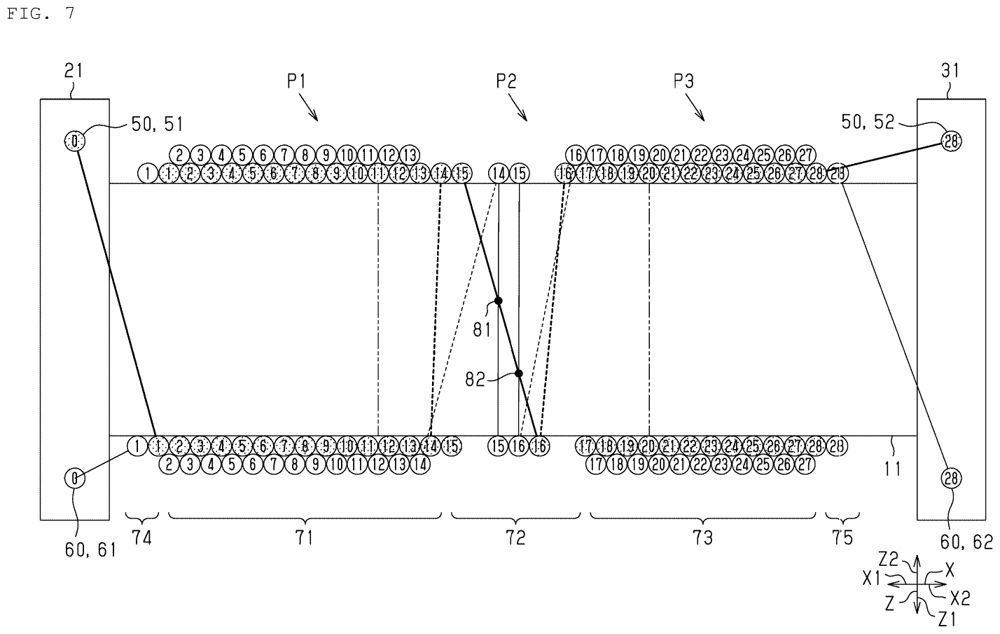

As shown in FIG. 7, in the third embodiment, the last turn of the first wire 50 is the 28th turn. In the third embodiment, the last turn of the second wire 60 is the 28th turn.

The first wire 50 is directly wound around the outer peripheral surface of the winding core 11 without interposing the second wire 60 therebetween in the entire circumference. In the first wire 50, from the first turn to the middle of the 15th turn, the turns are in contact with each other in the direction along the central axis X. On the other hand, a 15.0 turn portion and a 16.0 turn portion of the first wire 50 are separated from each other in the direction along the central axis X. Then, from the 17th turn to the 28th turn of the first wire 50, the turns are in contact with each other in the direction along the central axis X.

The second wire 60 includes the first wound portion 71, the second wound portion 72, and the third wound portion 73.

The first wound portion 71 is a portion of the second wire 60 wound around the outer peripheral side of the first wire 50 over a plurality of turns. In the third embodiment, the first wound portion 71 is a portion from the second turn to the middle of the 14th turn of the second wire 60. That is, the first wound portion 71 is a portion of the second wire 60 from a portion riding on the outer peripheral side of the first wire 50 to a portion immediately before being directly wound around the outer peripheral surface of the winding core 11.

Here, I is a positive integer. Further, a groove formed by two adjacent turns of the wire is defined as a valley of the wire. At this time, in the first wound portion 71, the I-th turn of the second wire 60 is located between the (I−1)-th turn of the first wire 50 and the I-th turn of the first wire 50. Specifically, for example, the second turn of the second wire 60 is located at the valley between the first turn of the first wire 50 and the second turn of the first wire 50.

The second wire 60 moves from the outer peripheral side of the first wire 50 onto the outer peripheral surface of the winding core 11 in the middle of the 14th turn. Specifically, the second wire 60 moves to the outer peripheral side of the winding core 11 within the range of 14.0 turns or more and less than 14.5 turns (i.e., from 14.0 turns to less than 14.5 turns).

When the second wire 60 is traced from the first end 61 to the second end 62, the 14th turn of the second wire 60 crosses the 14th turn of the first wire 50 from the first flange 21 side to the second flange 31 side on a surface facing the downward direction Y2 of the winding core 11.

The second wound portion 72 is located on the second flange 31 side with respect to the first wound portion 71 in the direction along the central axis X. The second wound portion 72 is a portion of the second wire 60, at least a part of which is wound around the outer peripheral side of the winding core 11. Specifically, the second wound portion 72 is a portion of the second wire 60 from the middle of the 14th turn to the middle of the 16th turn.

The 14th turn of the second wire 60 is directly wound around the outer circumferential surface of the winding core 11 between the 15 turn of the first wire 50 and the 16 turn of the first wire 50 on the ridgeline on the upward direction Y1 side and the leftward direction Z2 side of the winding core 11. Then, the 15.0 turn portion and the 16.0 turn portion of the second wire 60 are directly wound around the outer peripheral surface of the winding core 11 between the 15.0 turn portion and the 16.0 turn portion of the first wire 50.

Then, the second wire 60 intersects the 15th turn of the first wire 50 in the 14th and 15th turns of the second wire 60. The term “intersect” used herein is the same as the term “intersect” in the first embodiment.

Specifically, the 14th turn of the second wire 60 has a first intersection 81 intersecting the 15th turn of the first wire 50. Further, the 15th turn of the second wire 60 has a second intersection 82 intersecting the 15th turn of the first wire 50.

That is, in the second wound portion 72, when the second wire 60 is traced from the first end 61 to the second end 62, the second wire 60 has the first intersection 81 and the second intersection 82 intersecting one specific turn of the first wire 50 within a range where the second wire 60 is wound by two turns. Note that also in the present embodiment, when viewed toward the direction orthogonal to the central axis X of the winding core 11, the portion where the center lines of the wires overlap each other is referred to as the “intersection”.

When the second wire 60 is traced from the first end 61 to the second end 62, the first intersection 81 is a portion crossing the first wire 50 from the second flange 31 side to the first flange 21 side in the direction along the central axis X. Similarly, the second intersection 82 is a portion where the second wire 60 crosses the first wire 50 from the second flange 31 side to the first flange 21 side in the direction along the central axis X.

The first intersection 81 and the second intersection 82 are located on the outer peripheral surface of the winding core 11 facing the upward direction Y1. In other words, the first intersection 81 and the second intersection 82 are located on the outer peripheral surface of the winding core 11 on the upward direction Y1 side with respect to the central axis X. That is, the first intersection 81 is located at or after an about 14.75 turn portion in the 14th turn. Similarly, the second intersection 82 is located at or after an about 15.75 turn portion in the 15th turn.

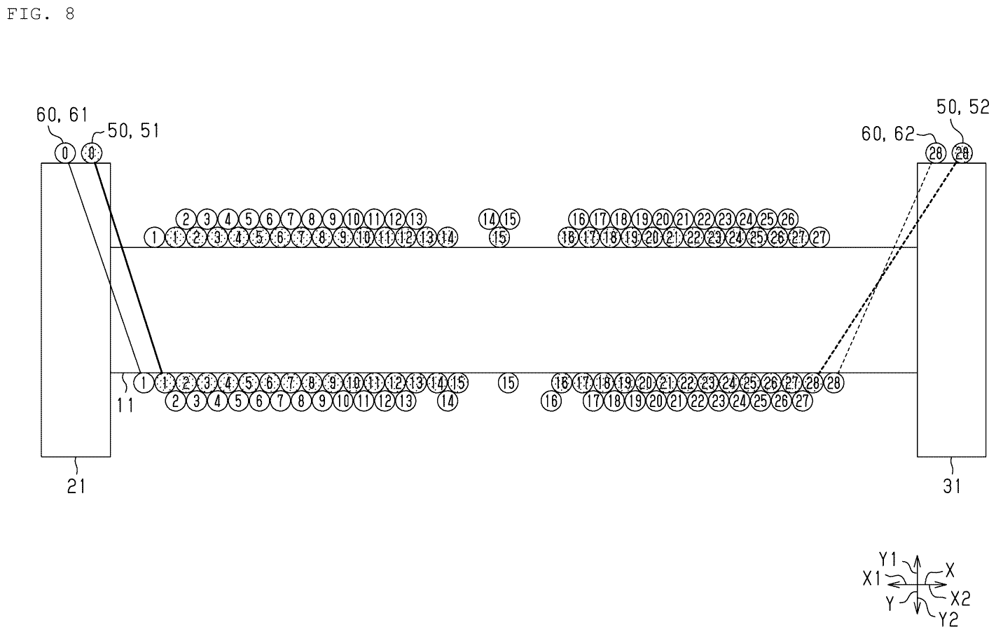

The second wire 60 rides on the outer peripheral side of the first wire 50 from the outer peripheral surface of the winding core 11 in the middle of the 16th turn. Specifically, as shown in FIG. 8, the second wire 60 rides on the outer peripheral side of the winding core 11 within a range of 16.0 turns or more and less than 16.5 turns (i.e., from 16.0 turns to less than 16.5 turns).

As shown in FIG. 7, when the second wire 60 is traced from the first end 61 to the second end 62, the 16th turn of the second wire 60 crosses the 16th turn of the first wire 50 from the first flange 21 side to the second flange 31 side on the surface facing the downward direction Y2 of the winding core 11.

The third wound portion 73 is located on the second flange 31 side with respect to the second wound portion 72 in the direction along the central axis X. The third wound portion 73 is a portion of the second wire 60 wound around the outer peripheral side of the first wire 50 over a plurality of turns. In the third embodiment, the third wound portion 73 is a portion from the middle of the 16th turn to the 27th turn of the second wire 60. That is, the third wound portion 73 is a portion of the second wire 60 from a portion riding on the outer peripheral side of the first wire 50 to a portion immediately before being directly wound around the outer peripheral surface of the winding core 11.

The 16th turn of the second wire 60 is located at a valley between the 16th turn of the first wire 50 and the 17th turn of the first wire 50 on the ridge line on the upward direction Y1 side and the leftward direction Z2 side of the winding core 11. Then, from the 17th turn of the second wire 60 to the 27th turn of the second wire 60, the I-th turn of the second wire 60 is located at the valley between the I-th turn of the first wire 50 and the (I+1)-th turn of the first wire 50.

The second wire 60 includes a fourth wound part 74 and a fifth wound part 75.

The fourth wound part 74 is located on the first flange 21 side with respect to the first wound portion 71 in the direction along the central axis X. The fourth wound part 74 is the first turn of the second wire 60. The first turn of the second wire 60 is located on the first flange 21 side in the direction along the central axis X with respect to the first turn of the first wire 50.

The fifth wound part 75 is located on the second flange 31 side with respect to the third wound portion 73 in the direction along the central axis X. The fifth wound part 75 is the 28th turn of the second wire 60. The 28th turn of the second wire 60 is located on the second flange 31 side in the direction along the central axis X with respect to the 28th turn of the first wire 50.

### <Positional Relationship of Intersection>

Here, it is assumed that N is an integer of 3 or more, and a specific one turn of the first wire 50 is an N-th turn of the first wire 50. As described above, the first intersection 81 and the second intersection 82 of the second wire 60 intersect the 15th turn of the first wire 50. Then, the first intersection 81 is the 14th turn, and the second intersection 82 is the 15th turn. Therefore, when N is 15, the first intersection 81 is the (N−1)-th turn of the second wire 60. Further, the second intersection 82 is the N-th turn of the second wire 60.

As described above, in the first wound portion 71, the I-th turn of the second wire 60 is located at a valley between the (I−1)-th turn of the first wire 50 and the I-th turn of the first wire 50. Specifically, the 13th turn of the second wire 60 is located at a valley between the 12th turn and the 13th turn of the first wire 50. In other words, the (N−2)-th turn of the second wire 60 is wound around the outer peripheral side of the first wire 50 between the (N−3)-th turn and the (N−2)-th turn of the first wire 50.

As described above, from the 17th turn of the second wire 60 to the 27th turn of the second wire 60, the I-th turn of the second wire 60 is located at the valley between the I-th turn of the first wire 50 and the (I+1)-th turn of the first wire 50. That is, the 17th turn of the second wire 60 is located at a valley between the 17th turn and the 18th turn of the first wire 50. In other words, the (N+2)-th turn of the second wire 60 is wound around the outer peripheral side of the first wire 50 between the (N+2)-th turn and the (N+3)-th turn of the first wire 50.

The last turn of the second wire 60 is located on the second flange 31 side in the direction along the central axis X with respect to the last turn of the first wire 50.

In the 14th turn of the second wire 60, the wire is directly wound around the outer peripheral surface of the winding core 11 except for the vicinity of the first intersection 81 and the vicinity of a 14.0 turn portion. Then, as described above, the first intersection 81 is located at or after the about 14.75 turn portion in the 14th turn. Therefore, the second wire 60 is wound around the outer peripheral surface of the winding core 11 by 0.5 turns or more in the turn having the first intersection 81.

In the 15th turn of the second wire 60, the wire is directly wound around the outer peripheral surface of the winding core 11 except for the vicinity of the second intersection 82. Then, as described above, the second intersection 82 is located at or after the about 15.75 turn portion in the 15th turn. Therefore, the second wire 60 is wound around the outer peripheral surface of the winding core 11 by 0.5 turns or more in the turn having the second intersection 82.

As shown in FIG. 7, it is assumed that the winding core 11 is equally divided into three regions in the direction along the central axis X. Then, the three regions are defined as a first region P1, a second region P2, and a third region P3 in this order from the first flange 21 side. At this time, the first intersection 81 and the second intersection 82 are located in the second region P2. That is, the first intersection 81 and the second intersection 82 are located in the central second region P2 among the three regions. Note that in FIG. 7, boundaries of the first region P1, the second region P2, and the third region P3 are virtually shown by two-dot chain lines.

### Effects of Third Embodiment

In the third embodiment, the following effects can be obtained in addition to the same effects as the effects (1-1), (1-2), (1-5), and (1-6) of the first embodiment and an effect (2-1) of the second embodiment.

(3-1) In the third embodiment, the (N−2)-th turn of the second wire 60 is wound around the outer peripheral side of the first wire 50 between the (N−3)-th turn and the (N−2)-th turn of the first wire 50. The (N+2)-th turn of the second wire 60 is wound around the outer peripheral side of the first wire 50 between the (N+2)-th turn and the (N+3)-th turn of the first wire 50. According to this configuration, the stray capacitance generated between different turns of the wires can be suppressed.

In the third embodiment, in the first wound portion 71, the I-th turn of the second wire 60 is located at a valley between the (I−1)-th turn of the first wire 50 and the I-th turn of the first wire 50. Further, in the third wound portion 73, the I-th turn of the second wire 60 is located at a valley of the I turn and the (I+1)-th turn of the first wire 50. According to this configuration, in the first wound portion 71 and the third wound portion 73, the stray capacitance can be suppressed by continuous turns.

(3-2) In the coil component 10, the last turn of each wire is drawn out toward the second flange 31 to be joined to each external electrode. Therefore, the last turn of each wire is pulled in a direction toward the second flange 31. Thus, the vicinity of the last turn of each wire may be displaced in the direction toward the second flange 31. In particular, when the first wire 50 is displaced in the direction toward the second flange 31, the second wire 60 wound around the outer peripheral side of the first wire 50 is also displaced, and overall winding disturbance of the wires may occur.

In the third embodiment, the last turn of the second wire 60 is located on the second flange 31 side from the last turn of the first wire 50 in the direction along the central axis X. According to such a positional relationship, also when the last turn of the first wire 50 is pulled toward the second flange 31, movement in the pulling direction is restricted by the last turn of the second wire 60. Therefore, according to this configuration, the overall winding disturbance of the wires as described above can be suppressed.

### Modification

The above embodiment can be modified and implemented as follows. The first embodiment, the second embodiment, the third embodiment, and the following modification can be implemented in combination within a range not technically contradictory.

In the first embodiment, the second embodiment, and the third embodiment, configuration of the coil component 10 is not limited to the above configuration. For example, the coil component 10 may not include the plate core 10F. Further, a shape of the plate core 10F is not limited to the rectangular plate shape. For example, the plate core 10F may have an elliptical plate shape or the like.

In the first embodiment, the second embodiment, and the third embodiment, a shape of the winding core 11 is not limited to examples of the above embodiments. For example, the shape of the winding core 11 may be a columnar shape or a polygonal columnar shape other than a quadrangular columnar shape.

In the first embodiment, the second embodiment, and the third embodiment, the materials of the drum core 10C and the plate core 10F are not limited to the examples of the above embodiments. For example, the materials of the drum core 10C and the plate core 10F are not limited to Ni—Zn-based ferrite, and may be Mn—Zn-based ferrite. Further, the materials of the drum core 10C and the plate core 10F may be ferrite, alumina, a synthetic resin, a mixture thereof, or the like.

In the first embodiment, the second embodiment, and the third embodiment, configuration of the drum core 10C is not limited to the examples of the above embodiments. For example, the first flange 21 may not include the projecting portion 23. Further, for example, the first flange 21 may be recessed at a central portion in the direction along the left-right axis Z and may have a bifurcated shape. The same applies to the second flange 31.

In the first embodiment, the second embodiment, and the third embodiment, a method of joining the joining part EP of each external electrode with each wire is not limited to the thermocompression bonding. For example, an end of each wire may be joined to the joining part EP by a laser, or may be joined by another method.

In the first embodiment, the second embodiment, and the third embodiment, a material and a shape of each external electrode are not limited to the examples of the above embodiments. Each external electrode can be joined to the first wire 50 and the second wire 60. For example, the external electrode may have a metal layer and a plating layer, and each wire may be connected to the plating layer. Further, for example, each external electrode may not have the bonding portion AP and the coupling portion BP. In this case, the external electrode is fixed to the corresponding flange by the joining part EP, the mount part CP, the extension DP, or any combination of them.

In the first embodiment, the second embodiment, and the third embodiment, each external electrode is not limited to a plate-like one. For example, each external electrode may be an applied electrode or the like obtained by applying an electrode paste to the first flange 21 or the second flange 31, baking the paste, and plating the paste.

In the first embodiment, the second embodiment, and the third embodiment, a value of N is not limited to 15. The value of N is an integer of 3 or more.

In the first embodiment, the second embodiment, and the third embodiment, the first intersection 81 and the second intersection 82 may not be located in the second region P2. Further, the first intersection 81 and the second intersection 82 may not be located in the same region.

In the first embodiment, the first intersection 81 is not limited to an intersection between the 15th turn of the first wire 50 and the 15th turn of the second wire 60. For example, the first intersection 81 may be an intersection between the 14th turn of the first wire 50 and the 16th turn of the second wire 60. As described above, the second wire 60 at the first intersection 81 may be a turn separated from the N-th turn of the first wire 50 by 2 turns or more. The same applies to the second embodiment and the third embodiment.

In the first embodiment and the second embodiment, the second wire 60 may not intersect the first wire 50 at a central turn among the turns wound around the winding core 11. That is, when the first intersection 81 is the N-th turn of the second wire 60, the last turn of the second wire 60 may not be the (2×N)-th turn. The same applies to the first wire 50. Further, when the second intersection 82 is the N-th turn of the second wire 60, the last turn of the second wire 60 may not be the (2×N)-th turn.

In the first embodiment and the second embodiment, the first turn of the second wire 60 may be directly wound around the outer peripheral surface of the winding core 11 without interposing the first wire 50 therebetween. That is, the first turn of the second wire 60 may not be located in a valley formed by two adjacent turns of the first wire 50.

In the first embodiment and the second embodiment, the first turn of the second wire 60 may not be located between the first turn of the first wire 50 and the second turn of the first wire 50. Further, in the third embodiment, the first turn of the second wire 60 may not be located on the first flange 21 side with respect to the first turn of the first wire 50 in the direction along the central axis X.

In the first embodiment and the second embodiment, the last turn of the second wire 60 may not be located on the first flange 21 side with respect to the last turn of the first wire 50 in the direction along the central axis X. Further, in the third embodiment, the last turn of the second wire 60 may not be located on the second flange 31 side with respect to the last turn of the first wire 50 in the direction along the central axis X.

In the first embodiment and the second embodiment, when the second wire 60 is traced from the first end 61 to the second end 62, the first crossing 91 and the second crossing 92 may not be located on the second flange 31 side with respect to the second intersection 82 in the direction along the central axis X. That is, when the second wire 60 is traced from the first end 61 to the second end 62 in the turns before the first intersection 81 and the second intersection 82, the second wire 60 may have a portion crossing the first wire 50 from the first flange 21 side to the second flange 31 side in the direction along the central axis X. Further, in the first embodiment and the second embodiment, the first crossing 91 and the second crossing 92 may be located at different turns of the second wire 60.

In the first embodiment, the second embodiment, and the third embodiment, when the second wire 60 is traced from the first end 61 to the second end 62, the first intersection 81 and the second intersection 82 may cross the first wire 50 from the first flange 21 side to the second flange 31 side in the direction along the central axis X.

In the first embodiment, the second embodiment, and the third embodiment, the second wire 60 may be wound around the outer peripheral surface of the winding core 11 by less than 0.5 turns in the turn having the first intersection 81. Further, the second wire 60 may be wound around the outer peripheral surface of the winding core 11 by less than 0.5 turns in the turn having the second intersection 82. In each embodiment, when the second wire 60 is traced from the first end to the second end in the second wound portion 72, the second wire 60 has the first intersection 81 and the second intersection 82 within the range where the second wire 60 is wound by two turns.

In the first embodiment and the second embodiment, when the second wire 60 is traced from the first end 61 to the second end 62, the third intersection 83 may not be located on the second flange 31 side with respect to the second intersection 82 in the direction along the central axis X. That is, when the second wire 60 is traced from the first end 61 to the second end 62 in the turns before the first intersection 81 and the second intersection 82, the second wire 60 may have a portion crossing the first wire 50 from the first flange 21 side to the second flange 31 side in the direction along the central axis X.

In the first embodiment and the second embodiment, the third intersection 83 may be located at a different turn of the second wire 60. For example, the third intersection 83 may be a portion intersecting the (2×N)-th turn of the first wire 50 in the (2×N)-th turn of the second wire 60.

In the first embodiment and the second embodiment, the third intersection 83 may not be located on the upward direction Y1 side of the winding core 11 with respect to the central axis X. As a result, the third intersection 83 may be located on the outer peripheral surface of the winding core 11 in a direction different from a direction in which the external electrode is located in each flange.

In the first embodiment and the second embodiment, the second wire 60 may not have the first crossing 91, the second intersection 82, and the third intersection 83. Further, in the third embodiment, the 14th turn of the second wire 60 may not cross the 14th turn of the first wire 50. Further, in the third embodiment, the 16th turn of the second wire 60 may not cross the 16th turn of the first wire 50. That is, in each embodiment, if the second wire 60 includes the first intersection 81 and the second intersection 82, the winding form of each wire can be appropriately changed. For example, in the first embodiment, the second embodiment, and the third embodiment, the second wire 60 may further include an intersection and a crossing.

For example, in the third embodiment, the (N−2)-th turn of the second wire 60 may not be wound around the outer peripheral side of the first wire 50 between the (N−3)-th turn of the first wire 50 and the (N−2)-th turn of the first wire 50. Further, the (N+2)-th turn of the second wire 60 may not be wound around the outer peripheral side of the first wire 50 between the (N+2)-th turn and the (N+3)-th turn of the first wire 50.

### Supplementary Note

Technical ideas that can be derived from the above embodiments and modification will be described below.

[1] A coil component including a drum core including a columnar winding core, a first flange provided at a first end in a direction along a central axis of the winding core, and a second flange provided at a second end opposite to the first end of the winding core; a first external electrode and a second external electrode provided on the first flange; a third external electrode and a fourth external electrode provided on the second flange; a first wire wound around the winding core and having a first end connected to the first external electrode and a second end connected to the third external electrode; and a second wire wound around the winding core in the same direction as the first wire, and having a first end connected to the second external electrode and a second end connected to the fourth external electrode. The second wire includes a first wound portion wound around an outer peripheral side of the first wire over a plurality of turns; a second wound portion located on the second flange side with respect to the first wound portion in a direction along the central axis, at least a part of the second wound portion being wound around an outer peripheral surface of the winding core; and a third wound portion located on the second flange side with respect to the second wound portion in the direction along the central axis and wound around the outer peripheral side of the first wire over a plurality of turns. Also, when the second wire is traced from the first end to the second end in the second wound portion, the second wire has a first intersection and a second intersection intersecting a specific one turn of the first wire within a range where the second wire is wound by two turns.

[2] The coil component according to [1], in which the second wire has 0.5 turns or more wound around the outer peripheral surface of the winding core in a turn having the first intersection, and has 0.5 turns or more wound around the outer peripheral surface of the winding core in a turn having the second intersection.

[3] The coil component according to [1] or [2], in which the first intersection and the second intersection are portions where the second wire crosses the first wire from the second flange side to the first flange side in the direction along the central axis when the second wire is traced from the first end to the second end, and the second wire has a portion where the second wire crosses the first wire from the first flange side to the second flange side in the direction along the central axis when the second wire is traced from the first end to the second end in a turn after the first intersection and the second intersection.

[4] The coil component according to any one of [1] to [3], in which when N is an integer of 3 or more and a specific one turn of the first wire is an N-th turn of the first wire, the first intersection is in an N-th turn of the second wire, and the second intersection is in an (N+1)-th turn of the second wire.

[5] The coil component according to any one of [1] to [3], in which when N is an integer of 3 or more and a specific one turn of the first wire is an N-th turn of the first wire, the first intersection is in an (N−1)-th turn of the second wire, and the second intersection is in an N-th turn of the second wire.

[6] The coil component according to any one of [1] to [5], in which a first turn of the second wire is located between a first turn of the first wire and a second turn of the first wire.

[7] The coil component according to any one of [1] to [6], in which a last turn of the second wire is located on the second flange side from a last turn of the first wire in the direction along the central axis.

[8] The coil component according to [4] or [5], in which a last turn of the first wire is a (2×N)-th turn, and a last turn of the second wire is a (2×N)-th turn.

[9] The coil component according to [5], in which an (N−2)-th turn of the second wire is wound around the outer peripheral side of the first wire between an (N−3)-th turn and an (N−2)-th turn of the first wire, and an (N+2)-th turn of the second wire is wound around the outer peripheral side of the first wire between an (N+2)-th turn and an (N+3)-th turn of the first wire.

[10] The coil component according to [8], in which a turn one turn before the (2×N)-th turn of the second wire has a third intersection intersecting a turn one turn before the (2×N)-th turn of the first wire.

[11] The coil component according to [8], in which the (2×N)-th turn of the second wire has a third intersection intersecting the (2×N)-th turn of the first wire.

[12] The coil component according to any one of [1] to [11], in which the second wire has a third intersection intersecting the first wire in a turn different from a turn having the first intersection and a turn having the second intersection, when a specific axis orthogonal to the central axis is an up-down axis and one of directions along the up-down axis is an upward direction, the first external electrode and the second external electrode are located on the upward direction side of the first flange with respect to the central axis, the third external electrode and the fourth external electrode are located on the upward direction side of the second flange with respect to the central axis, and the third intersection is located on the upward direction side of the winding core with respect to the central axis.

[13] The coil component according to any one of [1] to [12], in which when the winding core is equally divided into three regions in the direction along the central axis, the first intersection and the second intersection are located in a central region of the three regions.

What is claimed is:

1. A coil component comprising:
a drum core including a columnar winding core, a first flange at a first end in a direction along a central axis of the winding core, and a second flange at a second end opposite to the first end of the winding core;
a first external electrode and a second external electrode on the first flange;
a third external electrode and a fourth external electrode on the second flange;
a first wire wound around the winding core and having a first end connected to the first external electrode and a second end connected to the third external electrode; and
a second wire wound around the winding core in the same direction as the first wire, and having a first end connected to the second external electrode and a second end connected to the fourth external electrode,
wherein the second wire includes:
a first wound portion wound in a plurality of turns around an outer peripheral side with respect to the first wire;
a second wound portion on the second flange side with respect to the first wound portion in a direction along the central axis, at least a part of the second wound portion being wound around an outer peripheral surface of the winding core; and
a third wound portion on the second flange side with respect to the second wound portion in the direction along the central axis, and wound in a plurality of turns around the outer peripheral side with respect to the first wire, and
when the second wire is traced from the first end to the second end in the second wound portion, the second wire includes a first intersection and a second intersection which intersect a specific one turn of the first wire within a range where the second wire is wound by two turns.

2. The coil component according to claim 1, wherein
the second wire includes 0.5 turns or more wound around the outer peripheral surface of the winding core in a turn having the first intersection, and includes 0.5 turns or more wound around the outer peripheral surface of the winding core in a turn having the second intersection.

3. The coil component according to claim 1, wherein
the first intersection and the second intersection are portions where the second wire crosses the first wire from the second flange side to the first flange side in the direction along the central axis when the second wire is traced from the first end to the second end, and
the second wire has a portion where the second wire crosses the first wire from the first flange side to the second flange side in the direction along the central axis when the second wire is traced from the first end to the second end in a turn after the first intersection and the second intersection.

4. The coil component according to claim 1, wherein
when N is an integer of 3 or more and a specific one turn of the first wire is defined as an N-th turn of the first wire,
the first intersection is in an N-th turn of the second wire, and
the second intersection is in an (N+1)-th turn of the second wire.

5. The coil component according to claim 1, wherein
when N is an integer of 3 or more and a specific one turn of the first wire is defined as an N-th turn of the first wire,
the first intersection is in an (N−1)-th turn of the second wire, and
the second intersection is in an N-th turn of the second wire.

6. The coil component according to claim 1, wherein
a first turn of the second wire is between a first turn of the first wire and a second turn of the first wire.

7. The coil component according to claim 1, wherein
a last turn of the second wire is on the second flange side nearer than a last turn of the first wire in the direction along the central axis.

8. The coil component according to claim 4, wherein
a last turn of the first wire is a (2×N)-th turn, and
a last turn of the second wire is a (2×N)-th turn.

9. The coil component according to claim 5, wherein
an (N−2)-th turn of the second wire is wound around the outer peripheral side of the first wire between an (N−3)-th turn and an (N−2)-th turn of the first wire, and
an (N+2)-th turn of the second wire is wound around the outer peripheral side of the first wire between an (N+2)-th turn and an (N+3)-th turn of the first wire.

10. The coil component according to claim 8, wherein
a turn one turn before the (2×N)-th turn of the second wire has a third intersection intersecting a turn one turn before the (2×N)-th turn of the first wire.

11. The coil component according to claim 8, wherein
the (2×N)-th turn of the second wire includes a third intersection intersecting the (2×N)-th turn of the first wire.

12. The coil component according to claim 1, wherein
the second wire includes a third intersection intersecting the first wire in a turn different from a turn including the first intersection and a turn including the second intersection,
when a specific axis orthogonal to the central axis is defined as an up-down axis and one of directions along the up-down axis is defined as an upward direction,
the first external electrode and the second external electrode are on the upward direction side of the first flange with respect to the central axis,
the third external electrode and the fourth external electrode are on the upward direction side of the second flange with respect to the central axis, and
the third intersection is on the upward direction side of the winding core with respect to the central axis.

13. The coil component according to claim 1, wherein
when the winding core is equally divided into three regions in the direction along the central axis, the first intersection and the second intersection are in a central region of the three regions.

14. The coil component according to claim 5, wherein
a last turn of the first wire is a (2×N)-th turn, and
a last turn of the second wire is a (2×N)-th turn.

15. The coil component according to claim 14, wherein
a turn one turn before the (2×N)-th turn of the second wire has a third intersection intersecting a turn one turn before the (2×N)-th turn of the first wire.

16. The coil component according to claim 14, wherein
the (2×N)-th turn of the second wire includes a third intersection intersecting the (2×N)-th turn of the first wire.
